(19) United States
(12) Patent Application Publication
(10) Pub. No.: US 2025/0285805 A1
(43) Pub. Date: Sep. 11, 2025

(54) MULTILAYER COIL COMPONENT

(71) Applicant: TDK Corporation, Tokyo (JP)

(72) Inventors: Takeshi SHIBAYAMA, Tokyo (JP); Yusuke Nagai, Tokyo (JP); Keito Yasuda, Tokyo (JP); Hidenobu Umeda, Tokyo (JP); Kouichi Kakuda, Tokyo (JP)

(73) Assignee: TDK Corporation, Tokyo (JP)

(21) Appl. No.: 19/069,385

(22) Filed: Mar. 4, 2025

(30) Foreign Application Priority Data
Mar. 5, 2024 (JP) 2024-033186

(51) Int. Cl. H01F 27/34

(52) U.S. Cl. CPC H01F 27/34

(57) ABSTRACT

A coil component including: a coil conductor arranged in a coil form and placed inside an element body, a magnetic material layer including metal particles and arranged between a pair of conductor layers of the coil conductor adjacent along an axis direction of a cross section of the element body, and a resistance layer including ceramic particles having higher insulation resistance than the metal particles and arranged between the magnetic material layer and at least one of the pair of conductor layers. A mixture layer arranged between the magnetic material layer and the resistance layer, and including the ceramic particles between the metal particles in a predetermined ratio or higher.

### TECHNICAL FIELD

The present disclosure relates to a multilayer coil component which can be used as a multilayer inductor and the like.

### BACKGROUND

For example, a multilayer coil component shown in Patent Document 1 is known. In this multilayer coil component, a structure of a stress relieving layer adjacent to a coil conductor is disclosed. The stress relieving layer also functions as a resistance layer, and it has an effect to reduce short circuit malfunctions between the coil layers.

However, even if the resistance layer is placed in order to reduce the short circuit malfunctions, the present inventors have found that there is a risk of a decrease in withstand voltage, hence, improved withstand voltage is demanded.

### PRIOR ART DOCUMENT

### Patent Document

Patent Document 1: Japanese Patent Application Laid Open No.2017-59749

### SUMMARY

The object of the present disclosure is to provide a multilayer coil component with an excellent withstand voltage property.

A multilayer coil component including:
a coil conductor arranged in a coil form and placed inside an element body,
a magnetic material layer including soft magnetic metal particles and arranged between a pair of conductor layers of the coil conductor adjacent along an axis direction of a cross section of the element body,
a resistance layer including ceramic particles having higher insulation resistance than the soft magnetic metal particles and arranged between the magnetic material layer and at least one of the pair of conductor layers, and
a mixture layer arranged between the magnetic material layer and the resistance layer, and including the ceramic particles between the soft magnetic metal particles in a predetermined ratio or higher.

In this multilayer coil component, the resistance layer is arranged between the pair of conductor layers; thus, short circuit malfunctions can be effectively prevented, and also a desired inductance L can be secured which corresponds to materials of the soft magnetic metal particles included in the magnetic material layer. Also, the mixture layer, in which the ceramic particles exist in a predetermined ratio, exists between the resistance layer and the magnetic material layer; hence, a projection part of the metal particle existing at an interface between the resistance layer and the magnetic material layer is less likely to become a starting point of electric filed concentration. As a result, it is thought that a withstand voltage property improves.

Note that, in the case that the above-mentioned mixture layer is not formed, the projection part of the metal particle existing at the interface between the resistance layer and the magnetic material layer is likely to become the starting point of electric field concentration and thought to cause dielectric breakdown. When dielectric breakdown takes place, inductance L declines significantly.

Preferably, an area ratio of the area including the ceramic particles in the mixture layer is 25% or more and 72% or less. When the area ratio of the ceramic particles in the mixture layer is within such range, short circuit malfunctions are prevented, the withstand voltage property improves, and the desired inductance L can be secured easily. Note that, the larger the above-mentioned area ratio, the more the withstand voltage tends to improve; and the smaller the above-mentioned area ratio, the more the inductance L tends to improve.

Preferably, an average particle size (D50) of the ceramic particles is ½ or less of an average particle size (D50) of the soft magnetic metal particles. When such relation is satisfied, short circuit malfunctions are prevented, the withstand voltage property is improved, and the desired inductance L can be secured.

The resistance layer includes
a first resistance layer contacting at least one of the pair of conductor layers,
a second resistance layer contacting the mixture layer, and
a stress relieving layer arranged between the first resistance layer and the second resistance layer.

Preferably, the resistance layer includes the ceramic particles and a resin. The ceramic particles are not particularly limited as long as the particles have a higher insulation property than the metal particles. Preferably, the ceramic particles include silicon oxide particles and/or zirconium oxide particles.

### BRIEF DESCRIPTION OF DRAWINGS

FIG. 1A is a partially transparent perspective view of a multilayer coil component according to one embodiment of the present disclosure.

FIG. 1B is a partially transparent perspective view of the multilayer coil component according to other embodiment of the present disclosure.

FIG. 2 is a schematic cross-sectional view along an II-II line shown in FIG. 1A.

FIG. 3A is an enlarged schematic cross-sectional view of a magnetic material layer positioned between coil conductors shown in a III part of FIG. 2.

FIG. 3B is an enlarged schematic cross-sectional view of a magnetic material layer between coil conductors according to further other embodiment of the present disclosure.

FIG. 4A is an explanatory view for explaining a mixture layer existing at an interface between the magnetic material layer and the coil conductor shown in FIG. 3A.

FIG. 4B is an explanatory view for calculating an area ratio of an area where ceramic particles exist in the mixture layer shown in FIG. 4A.

FIG. 5A is an explanatory view of a method for producing the multilayer coil component shown in FIG. 1A.

FIG. 5B is an explanatory view showing a subsequent step of FIG. 5A.

FIG. 5C is an explanatory view showing a subsequent step of FIG. 5B.

FIG. 5D is an explanatory view showing a subsequent step of FIG. 5C.

### DETAILED DESCRIPTION

In below, embodiments of the present disclosure are described.

### First Embodiment

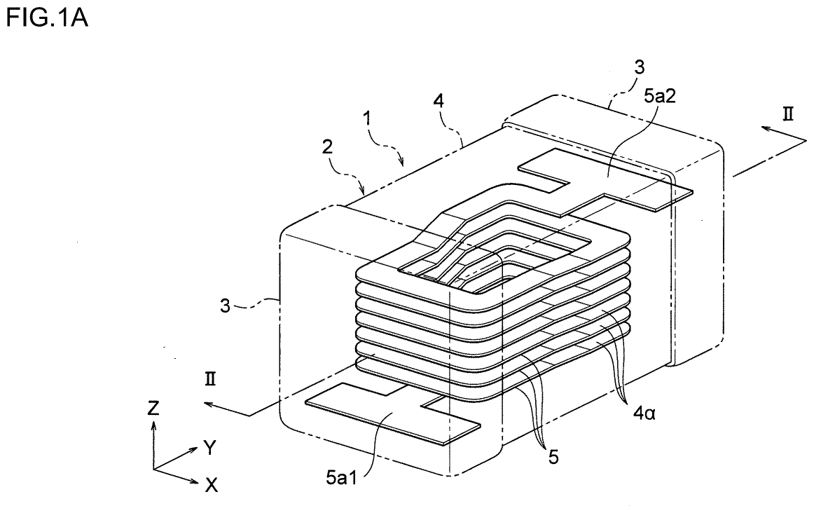

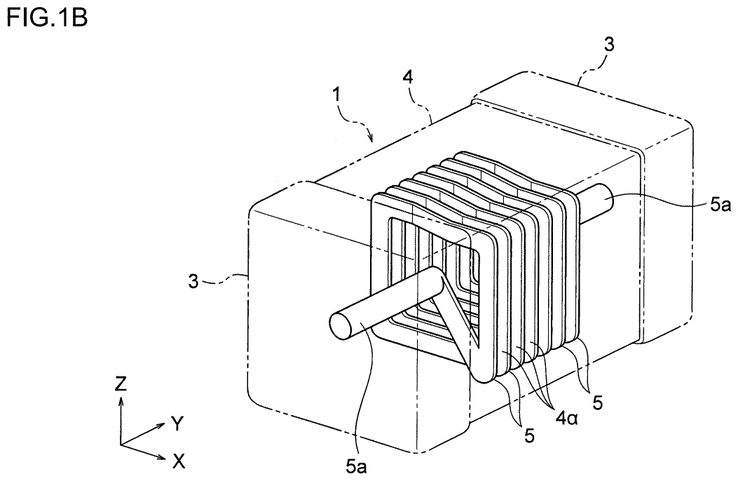

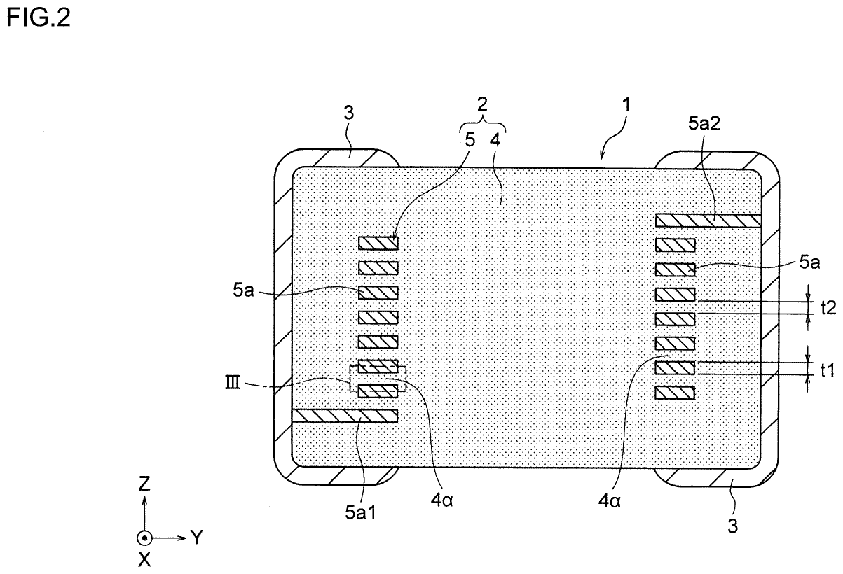

As shown in FIG. 1A and FIG. 2, a multilayer coil component 1 according to the present embodiment has an element 2 and a terminal electrode 3. The element 2 has a configuration that a coil conductor 5 is three dimensionally and spirally embedded inside an element body 4. The terminal electrode 3 is formed respectively to both ends of the element 2, and this terminal electrode 3 is connected to the coil conductor 5 via lead-out electrodes 5a1 and 5a2.

Note that, in FIG. 1A and the figures described later, an X-axis, a Y-axis, and a Z-axis are perpendicular to each other. Also, in the present embodiment, “inner side” refers to the side closer to the center of the multilayer coil component 1 (or the axis of the coil conductor 5), and “outer side” refers to the side away from the center of the multilayer coil component 1.

A material of the terminal electrode 3 is not particularly limited as long as it is an electrical conductor. Examples of the material of the terminal electrode 3 include Ag, Cu, Au, Al, Ag alloy, and Cu alloy. Particularly, Ag is preferable as it is inexpensive and has low resistance. The terminal electrode 3 may contain a glass frit. Also, the terminal electrode 3 may be formed on the element 2, and it may have a multilayer structure including a metal layer made of the above-mentioned metal or a combination of the above-mentioned metal and the glass frit, and a resin layer made of a conductive resin formed on the metal layer.

A type of metal contained in the conductive resin is not particularly limited. For example, Ag may be used. Also, plating may be performed on the surface of the terminal electrode 3. For example, Cu-plating, Ni-plating, Sn-plating, Cu—Ni—Sn plating, and/or Ni—Sn plating may be applied.

Materials of the coil conductor 5 and the lead out electrodes 5a1 and 5a2 are not particularly limited, as long as electrical conductor is used. For example, Ag, Cu, Au, Al, Ag alloy, and Cu alloy may be used. Particularly, Ag is preferably used as it is inexpensive and has low resistance. The coil conductor 5 may contain a glass frit.

The number of turns of the coil conductor 5 around a center axis is not particularly limited, and for example it may be 1.5 to 15.5 turns. Also, a thickness t1 of the coil conductor 5 (a thickness along the Z-axis) shown in FIG. 2 is not particularly limited, and for example, it may be 5 to 60 μm. Note that, FIG. 2 is a schematic cross-sectional view along a II-II line shown in FIG. 1A, and it shows a cross-section parallel to the Y-Z axis. That is, FIG. 2 is a cross-sectional view showing the lead-out terminals 5a1 and 5a2, and the terminal electrode 3.

As shown in FIG. 2, the element 2 can be divided into an axial end area, an axial center area, and an axial end area from bottom to top along a winding axis (parallel to the Z-axis) of the coil conductor 5. In other words, the element 2 can be divided into the axial center area where the coil conductor 5 is embedded and the axial end areas which are positioned on top and under the axial center area along an axis direction (the Z-axis direction) and not including the coil conductor 5. Note that, the axis direction of the coil conductor 5 is parallel to the layering direction of the coil conductor 5.

In the present embodiment, the area between conductive layers 5a of the coil conductor 5 adjacent to each other in the axis direction is defined as an interlayer area 4α. A thickness t2 of the interlayer area 4α in the Z-axis direction is not particularly limited, and for example, it may be 100 μm or less, 50 μm or less, 30 μm or less, 20 μm or less, 15 μm or less, 10 μm or less, 7 μm or less, or 4 μm or less.

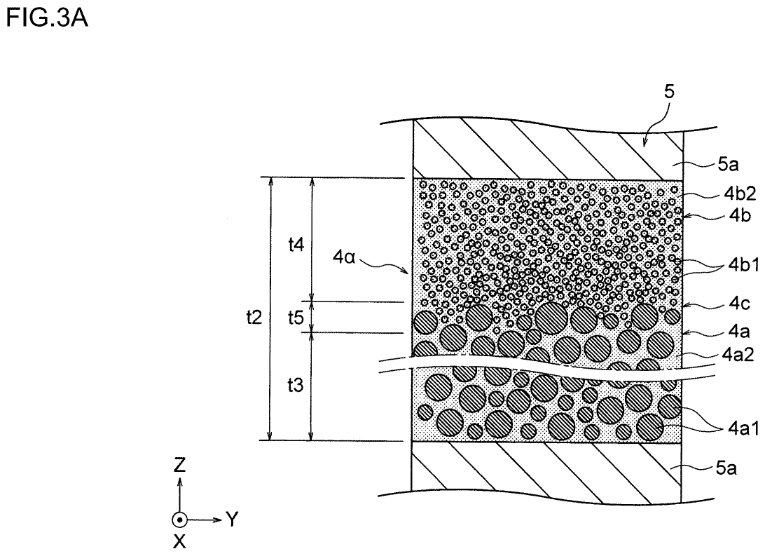

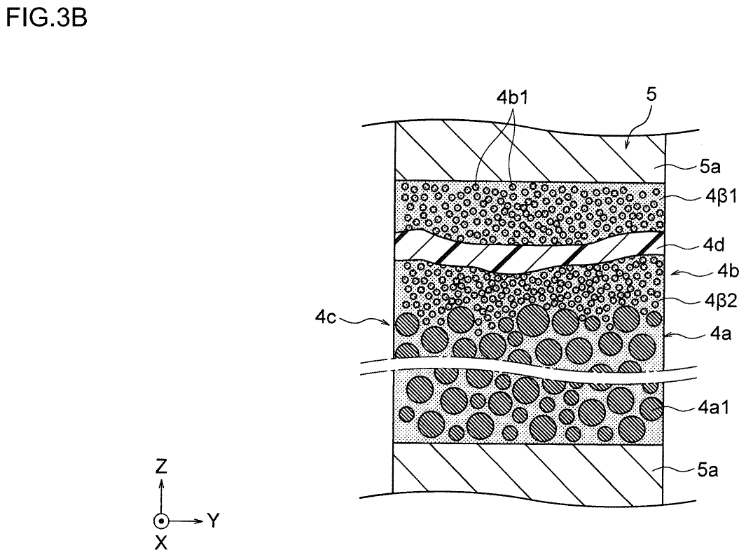

As shown in FIG. 3A, the interlayer area 4α includes a magnetic material layer 4a, a resistance layer 4b, and a mixture layer 4c existing at the interface between the magnetic material layer 4a and the resistance layer 4b. The magnetic material layer 4a includes soft magnetic metal particles 4a1 and a resin 4a2. A material of the soft magnetic metal particle 4a1 is not particularly limited. Examples of the material of the soft magnetic metal particle 4a1 include a Fe-based metal magnetic particle such as Fe—Si-based alloy, Fe—Si—Cr-based alloy, pure Fe, Fe—Co-based alloy, Fe—Ni-based alloy, Fe—Ni—Co-based alloy, and Fe—Si—Al-based alloy; and preferably it may be Fe—Si-based alloy. Note that, the metal particle 4a1 may include a metal particle other than the above-mentioned Fe-based metal particle.

A content of Fe in the metal particle is preferably 90.0 to 100.0 mass %, and more preferably 92.0 to 97.0 mass % with respect to 100 mass % of a total content of Fe and Si in the metal particle 4a1.

A content of Cr in the metal particle 4a1 is preferably 5 mass % or less, and more preferably less than 2 mass % with respect to 100 mass % of a total content of Fe and Si in the metal particle 4a1. Thereby, a balance between inductance and DC superimposition characteristics is improved, plating elongation suppression is improved, and also the number of times of short circuits is lowered.

A content of P in the soft magnetic metal particle 4a1 may be 10 to 700 ppm or less, and more preferably 40 to 650 ppm with respect to 100 mass % of a total content of Fe and Si in the soft magnetic metal particle 4a1. By doing so, a balance between inductance and DC superimposition characteristics is improved, plating elongation suppression is improved, and also the number of times of short circuits is lowered.

The resin 4a2 included in the magnetic material layer 4a is not particularly limited, and examples include a silicone resin, a phenol resin, an acrylic resin, an epoxy resin, a polyvinyl butyral resin, and an ethyl cellulose resin. The resin 4a2 exists between the metal particles 4a1 and it is used to insulate the metal particles 4a1 between each other. Note that, on the surface of each of the metal particles 4a1, a coating layer such as an oxidized insulation layer may be formed.

Specifically, the coating layer is preferably an oxidized coating layer, and the oxidized coating layer is preferably an oxide coating layer including an element which is easily oxidized than Fe, and the coating layer may include a layer made of oxides including Si. By coating the metal particle 4a1 with the coating layer, insulation between the metal particles 4a1 is enhanced, and thus Q-value improves. Also, when the oxidized coating layer includes the layer made of compounds including Si, it is possible to prevent oxides of Fe from forming. Note that, the metal particle 4a1 may be coated with another coating layer together with the oxide coating layer, or the metal particle 4a1 may be coated with another coating layer which is not the oxide coating layer.

The magnetic material layer 4a has a composition similar to the composition configuring the element body 4 other than the interlayer area 4α. Portion of the element body 4 other than the interlayer area 4α is formed similar to the magnetic material layer 4a as it will be described later.

The resistance layer 4b includes a ceramic particle 4b1 and a resin 4b2. As long as the ceramic particle 4b1 is a particle with a higher insulation property (insulation resistance) than the metal particle, it is not particularly limited. Examples of the ceramic particle 4b1 include an aluminum oxide particle, a silicon oxide particle, and a zirconium oxide particle; and preferably, the ceramic particle 4b1 includes a silicon oxide particle and/or a zirconium oxide particle. The ceramic particle may be crystalline or amorphous.

The resin 4b2 included in the resistance layer 4b may be the same as or different from the resin 4a2 included in the magnetic material layer 4a.

An average particle size (D50) of the ceramic particles 4b1 is preferably 1.0 μm or less, and more preferably 0.5 μm or less. Preferably, the average particle size is ½ or less of the particle size of the metal particle. When such relation is satisfied, short circuit malfunctions are prevented, a withstand voltage property is improved, and the desired inductance L can be secured easily. Note that, an average particle size (D50) of the metal particles 4a1 is preferably 1 to 15 μm, and more preferably 1 to 10 μm. Note that, the particle sizes of the particles 4a1 and 4b1 can be obtained by calculating from the cross-sectional areas of the particles.

The metal particle 4a1 is preferably a metal particle with high circularity; however, it does not necessarily have to be a metal particle of high circularity and it may be a flat metal particle. Also, the ceramic particle 4b1 is preferably a particle with high circularity.

A thickness t3 of the magnetic material layer 4a along the Z-axis is preferably ½ or thicker than the thickness t2 of the interlayer area 4α; and a sum (t4+t5) of a thickness t4 of the resistance layer 4b along the Z-axis and a thickness t5 of the mixture layer 4c along the Z-axis is preferably ½ or thinner than the thickness t2 of the interlayer area 4α. Note that, the thickness t3 of the magnetic material layer 4a along the Z-axis is a thickness of the area where the metal particle 4a1 exists but the ceramic particle 4b1 does not exist, and preferably a thickness t4 of the resistance layer 4b along the Z-axis is a thickness along the Z-axis of the area where the ceramic particle 4b1 exists but the metal particle 4a1 does not exist, and preferably the thickness t4 is 0.1 μm or thicker. Also, the thickness t5 of the mixture layer 4c is a thickness of an area along the Z-axis where the ceramic particles 4b1 exist between the metal particles 4a1 in a predetermined ratio or greater. The thickness t5 of the mixture layer 4c is preferably a thickness which is equal to or thicker than a distance t6 as it is described later.

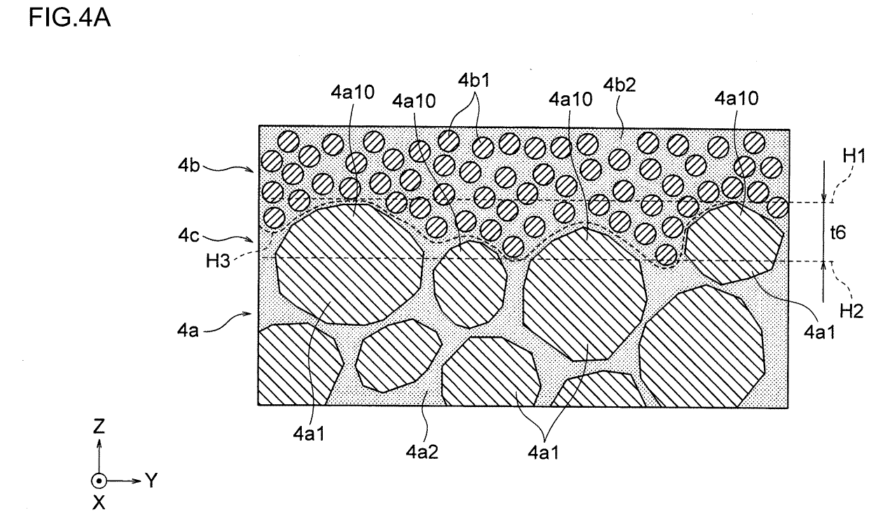

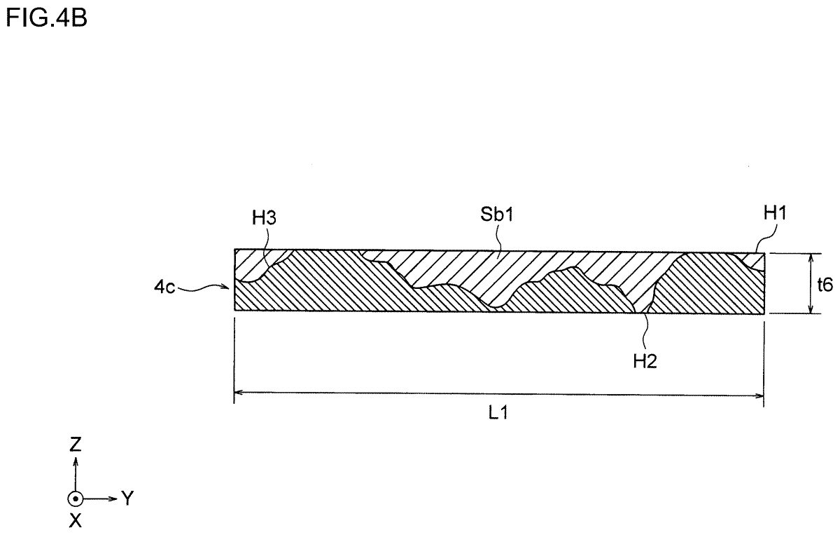

Following shows a method for measuring a ratio of the ceramic particles 4b1 existing between the metal particles 4a1 in the mixture layer 4c. As shown in FIG. 4A, an observation target is a cross section near the interface between the magnetic material layer 4a and the resistance layer 4b where 10 or more metal particles 4a1 are observed and also 50 or more ceramic particles 4b1 are observed.

A first hypothetical line H1 is on the cross section which is observed using SEM, STEM, and the like. The first hypothetical line H1 connects a point on the circumference of the soft magnetic metal particle 4a1 closest to the resistance layer 4b and a point on the circumference of the soft magnetic metal particle second closest to the resistance layer 4b along the Z-axis. Next, a second hypothetical line H2 is made which is parallel to and has a predetermined distance t6 from the first hypothetical line H1 towards the magnetic material layer 4a. To determine the predetermined distance t6, the average particle size of the metal particles 4a1 is obtained from the observed cross section, and the predetermined distance t6 is set to ½ of said average particle size. Note that, in order to calculate the average, preferably, 10 or more particles are used to calculate the average.

An area ratio that the ceramic particles 4b1 occupying the range between the first hypothetical line H1 and the second hypothetical line H2 is obtained; and, when the area ratio is 25% or more and 72% or less, it is defined as the mixture layer 4c where the ceramic particles 4b1 exist in a predetermined ratio or more between the metal particles 4a1. Note that, the thickness t5 of the mixture layer 4c shown in FIG. 3A is a thickness which is equal to or thicker than the distance t6 used to determine the mixture layer 4c defined in FIG. 4A. When the ceramic particles 4b1 are in the magnetic material layer 4a across the range of the distance t6 shown in FIG. 4A, the thickness t5 of the mixture layer 4c shown in FIG. 3A is thicker than the distance t6 shown in FIG. 4A.

For example, the method for measuring the area ratio of ceramic particles 4b1 occupying the mixture layer 4c is carried out using image processing such as a method described in below. Within a range of the distance t6 shown in FIG. 4A, circumference points of the ceramic particles 4b1 closest to the magnetic material layer 4a among the ceramic particles 4b1 existing between the metal particles 4a1 are connected by a hypothetical interface line H3. Then, as shown in FIG. 4B, a ratio of an area Sb1 within a range of the distance t6 positioned closer to the first hypothetical line H1 than to the hypothetical interface line H3 is obtained as the area ratio of the ceramic particles 4b1 in the cross-section (the observation cross-section length L1×distance t6) of the observed mixture layer 4c. In the present embodiment, the observation cross-section length L1 is a length along the Y-axis, and it is not particularly limited as long as it is perpendicular to the Z-axis. It may also be an observation cross-section length along the X-axis or a length along the axis between the X-axis and the Y-axis.

Next, a method for producing the multilayer coil component 1 shown in FIG. 1A is described. First, an example of method for producing the metal particle 4a1 is described. In the present embodiment, as a raw material of the metal particle 4a1, a simple element or an alloy of the configurational element can be used, and examples include simple Fe, simple Si, simple Cr, simple Ni, simple Co, and simple Al.

In the present embodiment, the metal particle 4a1 can be obtained by using the method which is the same as a known method for producing the metal particle 4a1. Specifically, the metal particle 4a1 can be produced using a gas atomization method, a water atomization method, a rotational disk method, and the like.

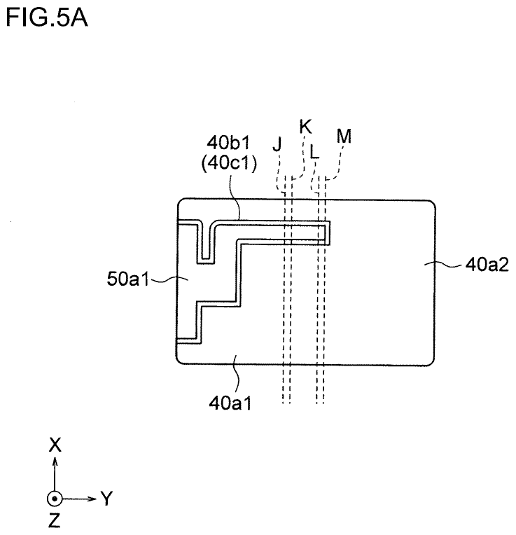

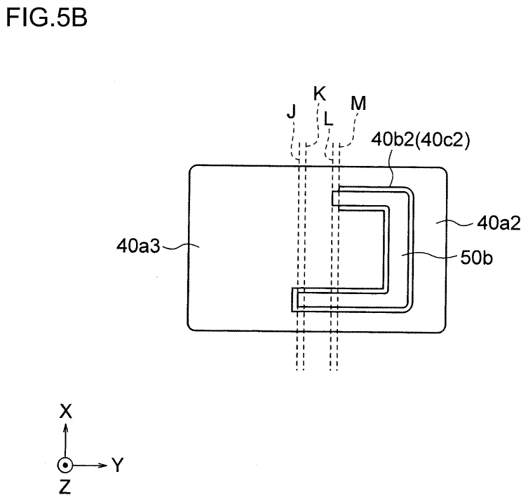

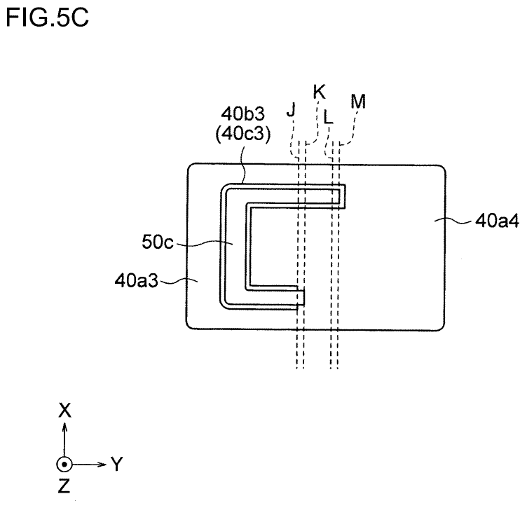

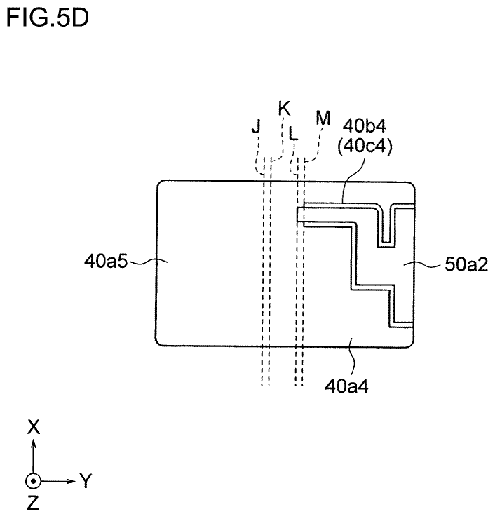

Next, the obtained metal particle 4a1 is mixed with an organic vehicle such as a binder and a solvent to form a slurry, and a magnetic material layer paste is prepared. Then, using the paste, for example, magnetic sheets 40a1 to 40a5 shown in FIG. 5A to FIG. 5D are formed which are used to configure the element body 4 shown in FIG. 2 and the magnetic material layer 4a shown in FIG. 3A after firing.

Regarding the organic vehicle, the binder (for example, a polyvinyl butyral-based resin, an ethyl cellulose-based resin, and an acrylic-based resin) and the solvent (for example, terpineol and butyl carbitol) are mixed in a blending ratio such as a binder to solvent of 5 to 20:80 to 95 (mass ratio); and the blending ratio of the organic vehicle can be adjusted to achieve an arbitrary viscosity to be used as the magnetic material layer paste. For example, as for the organic vehicle used for the magnetic material layer paste, a polyvinyl butyral resin can be used as the binder and butyl carbitol can be used as the solvent, and the mixing ratio of the binder to the solvent may be 10:90 (mass ratio). Note that, if necessary, additives selected from various dispersants, plasticizers, dielectrics, insulators, and the like may be added to the magnetic material layer paste.

Also, at the same time of or before or after preparing the magnetic material layer paste, a conductor paste for forming the coil conductor 5 shown in FIG. 1A and FIG. 2 is prepared. In the conductor paste, the metal particle for forming the coil conductor 5 is included together with the additives such as a solvent and a binder. For example, regarding the composition of the organic vehicle used for the conductor paste, an ethyl cellulose resin can be used as the binder and terpineol can be used as the solvent, and the mixing ratio of the binder to the solvent may be 10:90 (mass ratio). Note that, if necessary, the additives selected from various dispersants, plasticizers, dielectrics, insulators, and the like may be added to the conductor paste.

Also, at the same time of or before or after preparing the conductor paste, a resistor paste for forming the resistance layer 4b shown in FIG. 3A is prepared. In the resistor paste, the ceramic particle 4b1 for forming the resistance layer 4b is included together with the additives such as a solvent and a binder. For example, as for the composition of the organic vehicle used for the resistor paste, the same binder (which becomes the resin 4b2 shown in FIG. 3A) as the organic vehicle used for the magnetic material layer paste is used; however, it does not necessarily have to be the exact same.

Also, at the same time of or before or after preparing the resistor paste, if needed, a mixture paste for forming the mixture layer 4c shown in FIG. 3A is prepared. In said mixture paste, the ceramic particle 4b1 and the metal particle 4a1 for forming the mixture layer 4c are included together with the organic vehicle such as a solvent and a binder. For example, as for the composition of the organic vehicle used for the mixture paste, the same binder, solvent, and the like as the organic vehicle used for the resistor paste is used; however, it does not necessarily have to be the exact same.

For example, in order to form the lead-out electrode 5a1 shown in FIG. 1A and FIG. 2, the magnetic sheet 40a2 which is the right half from the dotted line J is printed on the magnetic sheet 40a1 shown in FIG. 5A, and a conductor pattern layer 50a1 is formed over the height difference of these magnetic sheets 40a1 and 40a2 by using a printing method or the like which uses a conductor paste. Also, before forming the conductor pattern layer 50a1, as similar to the case of forming the conductor pattern layer 50a1, the mixture pattern layer 40c1 is formed over the height difference of the magnetic sheets 40a1 and 40a2 by using a printing method which uses the mixture paste. Then, as similar to the case of forming the mixture pattern layer 40c1, the resistance pattern layer 40b1 is formed on the mixture pattern layer 40c1 by using a printing method or the like which uses the resistor paste. Then, the conductor patten layer 50a1 is formed on the resistor pattern layer 40b1 by using a printing method or the like which uses the conductor paste.

A width of the resistance pattern layer 40b1 (the width along the X-axis or the Y-axis/the same applies hereinbelow) is similar to the width of the mixture pattern layer 40c1, and it is preferably 1 to 10% or wider than the width of the conductor pattern layer 50a1. As shown in FIG. 3A, the width along the X-axis or the Y-axis of the resistance layer 4b positioned between the adjacent conductor layers 5a and 5a is made wider than the width along the X-axis or the Y-axis of the conductor layer 5a, thereby short circuits between the conductor layers 5a and 5a are effectively prevented.

Next, as shown in FIG. 5B, a magnetic sheet layer 40a3 is printed and formed on the left half from the dotted line L so that the most of the conductor pattern layer 50a1 shown in FIG. 5A is covered but exposes the pattern layer 50a1 between the dotted line L and the dotted line M. On the magnetic sheet layers 40a3 and 40a2, the mixture pattern layer 40c2, the resistance layer 40b2, and the conductor pattern layer 50b are formed as similar to the case of the mixture pattern layer 40c1, the resistance layer 40b1, and the conductor pattern layer 50a as shown in FIG. 5A.

As a result, the pattern layer 50a1 shown in FIG. 5A and the pattern layer 50b shown in FIG. 5B are connected between the dotted line L and the dotted line M. Note that, at the connection part of the pattern layer 50a shown in FIG. 5A and the pattern layer 50b shown in FIG. 5B, the mixture pattern layer 40c2 and the resistance layer 40b2 are not formed to the lower part of the pattern layer 50b along the Z-axis. This is to enable electrical connection between the pattern layer 50a shown in FIG. 5A and the pattern layer 50b shown in FIG. 5B.

Next, as shown in FIG. 5C, a magnetic sheet layer 40a4 is printed and formed on the right half from the dotted line K so that the most of the conductor pattern layer 50b show in FIG. 5B is covered but exposes the pattern layer 50b between the dotted line J and the dotted line K. On the magnetic sheet layers 40a3 and 40a4, the mixture pattern layer 40c3, the resistance layer 40b3, and the conductor pattern layer 50c are formed as similar to the case of the mixture pattern layer 40c2, the resistance layer 40b2, and the conductor pattern layer 50b as shown in FIG. 5B.

As a result, the pattern layer 50b shown in FIG. 5B and the pattern layer 50c shown in FIG. 5C are connected between the dotted line J and the dotted line K. Note that, at the connection part of the pattern layer 50b shown in FIG. 5B and the pattern layer 50c shown in FIG. 5C, the mixture pattern layer 40c3 and the resistance layer 40b3 are not formed to the lower part of the pattern layer 50c along the Z-axis. This is to enable electrical connection between the pattern layer 50b shown in FIG. 5B and the pattern layer 50c shown in FIG. 5C.

By repeating the printing process shown in FIG. 5B and the printing process shown in FIG. 5C, a conductor pattern layer corresponding to the coil conductor 5 of a spiral shape which is wound for a plurality of times as shown in FIG. 1A, a multilayer body corresponding to the interlayer areas 4α positioned between the conductive layer pattern can be obtained.

At the end of the spiral turns, as shown in FIG. 5D, a magnetic sheet 40a5 is printed and formed on the left half from the dotted line L so that the most of the conductor pattern layer 50c shown in FIG. 5C is covered but exposes the pattern layer 50c between the dotted line L and the dotted line M. On the magnetic sheet layers 40a4 and 40a5, the mixture pattern layer 40c4, the resistance layer 40b4, and the conductor pattern layer 50a2 are formed as similar to the case of the mixture pattern layer 40c3, the resistance layer 40b3, and the conductor pattern layer 50c as shown in FIG. 5C.

As a result, the pattern layer 50c shown in FIG. 5C and the pattern layer 50a2 shown in FIG. 5D are connected between the dotted line L and the dotted line M. The pattern layer 50a2 is a part which becomes the lead-out electrode 5a2 shown in FIG. 1A and FIG. 2 after firing. Note that, at the connection part of the pattern layer 50c shown in FIG. 5C and the pattern layer 50a2 shown in FIG. 5D, the mixture pattern layer 40c4 and the resistance layer 40b4 are not formed to the lower part of the pattern layer 50a2 along the Z-axis. This is to enable electrical connection between the pattern layer 50c shown in FIG. 5C and the pattern layer 50a2 shown in FIG. 5D.

Further, by using the magnetic material layer paste on a printed body shown in FIG. 5D, a part configuring the end area of the element body 4 along the Z-axis after firing is formed using a printing method or the like. Note that, a printing method is mentioned in above as an example of a method for producing the multilayer body, however, the multilayer body having the above-mentioned configuration may be obtained using a sheet method. Also, in the above-mentioned embodiment, the coil conductor 5 is formed using a printing method; however, it may be formed using a plating method.

Press processing (such as isostatic pressing) may be carried out to the obtained multilayer body during stacking process or after the stacking process in order to enhance density of the metal particles 4a1.

By performing heat treatment (a binder removal step and a firing step) to the obtained multilayer body, the binder is removed and a fired body (element 2) is obtained. A holding temperature (a binder removal temperature) during the binder removal step is not particularly limited as long as the binder is decomposed and removed as gas. For example, the holding temperature during the binder removal step may be 300° C. or higher and 450° C. or lower. Also, a holding time (a binder removal time) of the binder removal step is not particularly limited. For example, it may be 0.5 hours or longer and 2.0 hours or shorter.

A holding temperature of the firing step (a firing temperature) is not particularly limited as long as the metal particles configuring the soft magnetic metal powder can be connected with each other. The holding temperature may be 550° C. or higher and 850° C. or lower. Also, a holding time of the firing step (a firing time) is not particularly limited. It may be 0.5 hours or longer and 3.0 hours or shorter.

An annealing treatment (a heat treatment) may be carried out after firing. Conditions of the annealing treatment are not particularly limited. For example, the annealing treatment may be carried out at a temperature between 500 to 800° C. for 0.5 to 2.0 hours. Also, atmosphere after the annealing treatment is not particularly limited.

The fired body of the multilayer inductor has a space at the part other than the soft magnetic metal powder. By impregnating the resin into the fired body, the space is filled with the resin.

By filling the space with the resin, strength (particularly, bending strength) of the multilayer body is enhanced. Also, insulation between the soft magnetic metal particles of the soft magnetic metal powder is further enhanced; thus, inductance and Q-value improve easily. Further, reliability and heat resistance improve. Also, the multilayer inductor is less likely to have short circuits.

A method for impregnating the resin is not particularly limited. Examples of the method include vacuum impregnation. Vacuum impregnation is carried out by immersing the above-mentioned fired body in the resin, and then by controlling barometric pressure. By lowering the barometric pressure, the resin enters inside the fired body. That is, since the fired body has the above-mentioned space, the resin enters inside the fired body due to a capillary phenomenon via the space, particularly the resin can enter into the interlayer areas which is the most difficult area to enter. After impregnating the resin in the fired body, the resin is cured by heating. Heating conditions of the resin differ depending on a type of the resin.

The type of the resin is not particularly limited. Examples of the resin include a phenol resin, an epoxy resin, and a silicone resin.

A content of the resin in the fired body of the multilayer inductor obtained at the end is preferably 0.5 mass % or more and 3.0 mass % or less. Note that, the content of the resin can be regulated by adjusting a resin solution concentration during impregnation, an immersion time, a number of times of immersion, and so on.

Next, the terminal electrode 3 is formed to the element. A method for forming the terminal electrode 3 is not particularly limited; and for example, it is usually formed by making a slurry from the metal (Ag or the like) which becomes the terminal electrode 3 together with the additives such as a solvent and a binder.

The multilayer coil component 1 according to the present embodiment is obtained using the above-mentioned method. Particularly, in the present embodiment, as shown in FIG. 3A, in order to form the mixture layer 4c which includes the ceramic particles 4b1 in a predetermined ratio between the magnetic material layer 4a and the resistance layer 4b, the above-mentioned process is preferably carried out.

In the multilayer coil component 1 according to the present embodiment, as shown in FIG. 3A, the resistance layer 4b is arranged between the pair of conductor layers 5a and 5a; hence, short circuit malfunctions can be effectively prevented, and also the desired inductance L corresponding to the material of the soft magnetic metal particle 4a1 included in the magnetic material layer 4a can be secured. Also, the mixture layer 4c including the ceramic particles 4b1 in a predetermined ratio or higher exists between the resistance layer 4b and the magnetic material layer 4a; thus, the projection part 4a10 of the metal particle 4a1 existing at the interface between the resistance layer 4b and the magnetic material layer 4a is less likely to become a starting point of the electric filed concentration. As a result, it is thought that the withstand voltage property improves.

Note that, in the case that the mixture layer 4c shown in the above is not formed, the projection part 4a10 of the metal particle 4a1 existing at the interface between the resistance layer 4b and the magnetic material layer 4a is thought to become a starting point of the electric filed concentration and causes dielectric breakdown. When dielectric breakdown takes place, inductance L declines significantly.

In the present embodiment, an area ratio of the area including the ceramic particles 4b1 in the mixture layer 4c is 25% or more and 72% or less. When the area ratio is within such range, short circuit malfunctions are prevented, the withstand voltage property improves, and the desired inductance L can be easily secured. Note that, the larger the area ratio, the better the withstand voltage property tends to be, and the smaller the area ratio, the higher the inductance L tends to be. From such point of view, the above-mentioned area ratio is more preferably 28.4 to 70.2%.

Also, in the present embodiment, the average particle size (D50) of the ceramic particles is ½ or less of the average particle size (D50) of the metal particles. When such relation is satisfied, short circuit malfunctions are prevented, while the withstand voltage property improves and the desired inductance L can be secured easily.

### Second Embodiment

The second embodiment is described in below, and unless mentioned otherwise, the configuration is the same as the first embodiment.

In the present embodiment, the resistance layer 4b includes a first resistance layer 4β1 contacting at least one of the pair of conductor layers 5a and 5a which are adjacent to each other, a second resistance layer 4β2 contacting the mixture layer 4c, and a stress relieving layer 4d arranged between the first resistance layer 4β1 and the second resistance layer 4β2.

The first resistance layer 4β1 and the second resistance layer 4β2 both include the ceramic particles 4b1 as similar to the resistance layer 4b of the aforementioned first embodiment; however, it does not necessarily have to be the exact same, and the particle sizes or the like may be different. For example, the stress relieving layer 4d is configured of a void which does not include the ceramic particles 4b1, the resin or a glass paste layer which does not include the ceramic particles 4b1, or the combination of these.

A thickness of the stress relieving layer 4d along the Z-axis is preferably 0.1 μm to 10 μm. A thickness of each of the resistance layers 4β1 and 4β2 may be the same or different. Note that, the total thickness of the resistance layer 4b which includes the thickness of each of the resistance layers 4β1 and 4β2 and the thickness of the stress relieving layer 4d is set to be the same as the thickness t4 of the resistance layer 4b shown in FIG. 3A.

The stress relieving layer 4d configured of the void can be formed during the production, for example, by printing a paste including a foaming resin at a stacking position where the stress relieving layer 4d is to be formed, and then by heat treating it at the later step. Also, the stress relieving layer 4d configured of the resin layer or the glass paste layer can be produced by printing the paste layer made of these materials and then performing heat treatment.

The stress relieving layer 4d reduces the internal stress caused inside the element body 4; therefore, the multilayer coil component 1 can further effectively reduce cracks from forming between the conductor layers 5a and 5a. Therefore, this multilayer coil component can further effectively reduce the short circuits between the conductor layers 5a and 5a.

### Third Embodiment

Below describes the third embodiment, and unless mentioned otherwise, the configuration is basically the same as the first and second embodiments.

As shown in FIG. 1B, the multilayer coil component 1 according to the present embodiment has a configuration in which the coil conductor 5 arranged inside the element body 4 is embedded in a spiral form along the Y-axis. At the both ends of the element 2, the terminal electrodes 3 are formed, and the terminal electrodes 3 are connected to the coil conductor 5 via lead-out electrodes 5a and 5a. At the inside of the element 2, the cross-section of the interlayer area 4α positioned between the coil conductors 5 and 5 disposed in a close proximity along the Y-axis is the same as shown in FIG. 3A and FIG. 3B.

In above, the embodiments of the present disclosure are explained, however, the present disclosure is not limited to the above-mentioned embodiments, and various modifications may be possible within the scope of the present disclosure.

For example, in the above-mentioned embodiments, as shown in FIG. 5A to FIG. 5D, the mixture pattern layers 40c1 to 40c4 are formed on the magnetic sheet layers 40a1 to 40a4, and then the resistance pattern layer 40b1 is formed on the mixture pattern layers 40c1 to 40c4, and then the conductor pattern layers 50a1, 50b, 50c, and 50 a2 is formed on the resistance pattern layer 40b1. By forming in this sequence, the mixture layer 4c shown in FIG. 3A is formed.

However, in another embodiment, the resistance pattern layer 40b1 is formed on the magnetic sheet layers 40a1 to 40a4 without forming the mixture pattern layers 40c1 to 40c4, and then the conductor pattern layers 50a1, 50b, 50c, and 50a2 are formed on the resistance pattern layer 40b1. By forming in this sequence, the mixture layer 4c shown in FIG. 3A can be also formed. Note that, in such case, unlike the conventional method, the resistance pattern layers 40b1 to 40b4 are formed on the magnetic sheet layers 40a1 to 40a4, and then the conductor pattern layers 50a1, 50b, 50c, and 50a2 are formed on the resistance pattern layers 40b1 to 40b4. By forming the multilayer body in this sequence, for example, the multilayer body is passed through a pair of rollers to perform press processing in the Z-axis direction. By performing press processing in the Z-axis direction, the mixture layer 4c shown in FIG. 3A is easily formed at the interface between the magnetic material layer 4a and the resistance layer 4b.

Further, in the above-mentioned embodiment, the conductor 5 is formed using a printing method to the conductor paste, however, the conductor layer 5a of the conductor 5 can be formed using a plating method. Also, the magnetic material layer 4a is formed using a magnetic material substrate (or a magnetic sheet), and then the mixture layer 4c, the resistance layer 4b, and the conductor layer 5a may be formed and stacked using a printing method on the surface of the magnetic material substrate which becomes the magnetic material layer 4a. The conductor layer 5a of each layer may be connected using a through hole electrode or the like.

Also, the multilayer coil component according to the above-mentioned embodiments are suitably used as inductors, impedances, and the like for power circuits of various electronic devices such as mobile phones. However, the multilayer coil component according to the above-mentioned embodiments may be used for other usages as well.

### EXAMPLES

Hereinbelow, further detailed examples are described, however, the present disclosure is not limited to these examples.

### Example 1

An ingot, chunk (mass), or shot (particles) of simple Fe and simple Si were prepared so as to obtain a composition of 94 Fe-6 Si. Then, mixing was carried out, and a mixture was placed inside a crucible disposed in a gas atomization device. Next, under inert atmosphere, using a work coil provided outside of the crucible, the crucible was heated to 1600° C. or higher by high frequency induction heating. Thereby, the ingot, chunk, or shot inside the crucible was melted and mixed, and a molten was obtained.

Next, a gas stream of 1 to 10 MPa was collided against the molten supplied in a form of a continuous linear fluid from a nozzle provided to the crucible, thereby the molten was formed into droplets and also quenched at the same time, then dehydration, drying, and classification were carried out. A metal powder obtained through the above-mentioned steps was heat treated at 300° C. for 30 minutes in the air; thereby, the soft magnetic metal powder having Fe—Si-based alloy particles was produced. An average particle size D50 of the soft magnetic metal powder was 3.00 μm.

The obtained soft magnetic metal powder (the powder which becomes the metal particles 4a1 included in the magnetic material layer 4a) is formed into a slurry together with additives such as a solvent and a binder; thereby, the magnetic material layer paste was prepared. The magnetic material layer paste included 20 wt % of an organic vehicle with respect to 100 wt % of the soft magnetic metal powder. Here, the organic vehicle used for the magnetic material layer paste was prepared by mixing the binder (polyvinyl butyral resin) and the solvent (butyl carbitol) in a ratio of 10:90 (mass ratio). Then, using this magnetic material layer paste, the magnetic sheet layers 40a1 to 40a5 shown in FIG. 5A to FIG. 5D, which for example configures the element body 4 shown in FIG. 2 and the magnetic material layer 4a shown in FIG. 3A after firing, were formed using a printing method.

Also, at the same time or before or after forming the magnetic sheet layers 40a1 to 40a5, a conductor paste for forming the coil conductor 5 shown in FIG. 1A and FIG. 2 was prepared. In the conductor paste, Ag for forming the coil conductor 5 was included together with the additives such as a solvent and a binder. The conductor paste included 20 wt % of the organic vehicle with respect to 100 wt % of the Ag particles. Here, the organic vehicle used for the conductor paste was prepared by mixing the binder (ethyl cellulose resin) and the solvent (terpeniol) in a ratio of 10:90 (mass ratio). Then, using this conductor paste, the conductor pattern layers 50a1, 50b to 50c, and 50a2 shown in FIG. 5A to FIG. 5D, which for example configure the coil conductor 5 shown in FIG. 2 after firing, were formed using a printing method.

Also, at the same time or before or after forming the conductor pattern layers 50a1, 50b to 50c, and 50a2, a resistor paste for forming the resistance layer 4b shown in FIG. 3A was formed. The resistor paste included the ceramic particles 4b1 for forming the resistance layer 4b together with the organic vehicles such as a binder and a solvent. As the ceramic particles 4b1, silicon oxide particles having an average particle size D50 of 0.1 μm were used. As for the organic vehicle, the same vehicle used for the conductor paste was used. The resistor paste was formed under the conductor pattern layers 50a1 to 50a2 using a printing method to the resistance pattern layers 40b1 to 40b4 shown in FIG. 5A to FIG. 5D.

Also, at the same time or before or after forming the resistance pattern layers 40b1 to 40b4, a mixture paste for forming the mixture layer 4c shown in FIG. 3A was prepared. In the mixture paste, the ceramic particles 4b1 and the metal particles 4a1, which were to form the mixture layer 4c, were included in a predetermined ratio together with the organic vehicles such as a solvent and a binder. As the ceramic particle 4b1, the same ceramic particle 4b1 included in the resistor paste was used. Also, as the metal particle 4a1, the same metal particle included in the magnetic material layer paste was used.

As the organic vehicle of the mixture paste, the same organic vehicle used in the conductor paste was used. The mixture paste was formed by printing the mixture pattern layers 40c1 to 40c4 shown in FIG. 5A to FIG. 5D under the resistance patter layers 40b1 to 40b4 using a printing method.

By going through the steps shown in FIG. 5A to FIG. 5D, a green multilayer body of 0.8 mm was obtained. Note that, the coil conductor 5 was configured of Ag conductor, and the number of turns was 7.5 Ts.

The green multilayer body obtained as such was cut into a shape of 1.6 mm×0.8 mm, thereby green chips were obtained.

Next, a binder removal treatment was carried out to the obtained green chips under inert atmosphere (N₂ gas atmosphere) at 400° C. Then, the chips were fired under the condition of reducing atmosphere (the mixed gas atmosphere of N₂ gas and H₂ gas (hydrogen concentration of 1.0%)) at 750° C. for 1 hour; thereby, fired chips were obtained.

A terminal electrode paste was applied and dried on the both end surfaces of each of the obtained fired chip, and a baking treatment was carried out under atmosphere of 1% oxygen partial pressure at 700° C. for 1 hour. Then, electrolytic plating was performed to form a Ni plating layer and a Sn plating layer on the terminal electrodes, thereby the multilayer coil component 1 formed with the terminal electrodes 3 shown in FIG. 1A was obtained.

In regards with an internal dimension of the obtained multilayer coil component, a thickness (Te) of the coil conductor 5 shown in FIG. 2 was 20 μm, and a thickness (t2) of the interlayer area 4α was 10 μm.

Following analyses were carried out to the obtained multilayer coil component (inductance sample).

### Component Analysis

An element mapping image of the multilayer coil component of Example 1 was obtained, and a component analysis was carried out. As a result, it was confirmed that the metal particle 4a1 having the same composition as the soft magnetic metal powder used as the raw material was formed in the magnetic material layer 4a. Also, it was confirmed that the ceramic particle 4b1 having the same composition as the oxide silicon particle used as the raw material was formed in the resistance layer 4b. Also, the ceramic particle 4b1 and the metal particle 4a1 were confirmed in the mixture layer 4c.

### SEM Image Analysis

The coil component sample was cut at a perpendicular plane to the internal electrode layer, then the cross-section was wet polished to obtain a polished surface. Next, ion milling was carried out to the polished surface. A SEM image as shown in FIG. 3A of the polished surface at the center part of the chip after ion milling was observed.

From the cross-section shown in FIG. 3A, the mixture layer 4c including the ceramic particles 4b1 in a predetermined ratio or more at the interface between the magnetic material layer 4a and the resistance layer 4b was observed using the above-mentioned method shown in FIG. 4A. As shown in FIG. 4B, the image was binarized, and a ratio of the area where the ceramic particles 4b1 and a ratio of the area of the metal particles 4a1 existing in the range of the predetermined length t6 were obtained. Results are shown in Table 1.

Note that, an average particle size D50 of the metal particles 4a1 in the cross-section was 3.00 μm. Also, an average particle size D50 of the ceramic particles 4b1 in the cross-section was 0.23 μm.

### Inductance

Regarding 50 inductance samples, RF impedance analyzer (E4991A made by Keysight Technologies) and Test Fixture (16192A made by Keysight Technologies) were used to measure inductance L. Measurement conditions were a measurement frequency of 10 MHz, and a measurement temperature of 25° C. Results are shown in Table 1.

### Withstand Voltage

Also, separate from the inductance samples, capacitor samples were produced using the same material and means so that a thickness between the electrode layers was the same as the thickness t2 of the interlayer 4α, and the number of stacked layers of the conductors was three layers. In regards with the capacitor samples, the withstand voltage evaluation was carried out as described in below.

In regards with the capacitor samples of five or more, DC voltage was applied at a voltage rising speed of 10 V/sec to the samples, and the voltage when 10 mA of leakage current was observed was measured, then it was divided by the thickness between the conductors. The average of these was defined as the withstand voltage. The withstand voltage of 0.5 V/μm or higher was considered good. Results are shown in Table 1.

### Examples 2 to 12

Inductor samples and capacitor samples were produced as similar to Example 1, except that the number ratio of the metal particles 4a1 and the ceramic particles 4b1 in the mixture paste were adjusted so that an area ratio of the ceramic particles within the range of the distance t6 shown in FIG. 4A satisfied the values shown in Table 1. Then, the same evaluations were carried out. Results are shown in Table 1.

### Comparative Example 1

An inductor sample and a capacitor sample were produced as similar to Example 1, except that the mixture paste was not printed so that an area ratio of the ceramic particles in the range of the distance t6 shown in FIG. 4A satisfied the value shown in Table 1. Then, the same evaluations were carried out. Results are shown in Table 1.

### Evaluation 1

When the area ratio of ceramic particles in the range of the distance t6 shown in FIG. 4A was 25% or more and 72% or less, more preferably 28.4% or more and 70.2% or less compared to Comparative example 1, it was confirmed that withstand voltage was improved while maintaining inductance L.

### Example 13

An inductor sample and a capacitor sample were produced as similar to Example 3 except that the material of the ceramic particles 4b1 included in the resistance layer 4b and the mixture layer 4c were changed from silicon oxide (SiO₂) to zirconium oxide (ZrO₂). Then, the same evaluations were carried out. Results are shown in Table 2.

### Example 14

An inductance sample and a capacitor sample were produced as similar to Example 3 except that the material of the metal particles 4a1 included in the magnetic material layer 4a and the mixture layer 4c was changed from Fe—Si to Fe—Ni. Then, the same evaluations were carried out. Results are shown in Table 2.

### Example 15

An inductance sample and a capacitor sample were produced as similar to Example 3 except that the material of the metal particles 4a1 included in the magnetic material layer 4a and the mixture layer 4c was changed from Fe—Si to Fe—Ni—Co. Then, the same evaluations were carried out. Results are shown in Table 2.

### Comparative Example 2

An inductor sample and a capacitor sample were produced as similar to Example 13 except that the number ratio of the metal particles 4a1 and the ceramic particles 4b1 in the mixture paste were adjusted so that an area ratio of the ceramic particles within the range of the distance t6 shown in FIG. 4A satisfied the value shown in Table 2. Then, the same evaluations were carried out. Results are shown in Table 2.

### Comparative Example 3

An inductor sample and a capacitor sample were produced as similar to Example 14 except that the number ratio of the metal particles 4a1 and the ceramic particles 4b1 in the mixture paste were adjusted so that an area ratio of the ceramic particles within the range of the distance t6 shown in FIG. 4A satisfied the value shown in Table 2. Then, the same evaluations were carried out. Results are shown in Table 2.

### Comparative Example 4

An inductor sample and a capacitor sample were produced as similar to Example 15 except that the number ratio of the metal particles 4a1 and the ceramic particles 4b1 in the mixture paste were adjusted so that an area ratio of the ceramic particles within the range of the distance t6 shown in FIG. 4A satisfied the value shown in Table 2. Then, the same evaluations were carried out. Results are shown in Table 2.

TABLE 1

| | Area ratio (%) in mixture | | | | |
|---|---|---|---|---|---|
| | layer | | | Evaluation | |
| | | Soft | | of capacitor | |
| | | magnetic | | sample | Evaluation |
| | Ceramic | metal | | Withstand | of inductor |
| | particle | particle | | voltage | sample |
| | (SiO2) | (FeSi) | Total | (V/μm) | Ls (nH) |
| Comparative | 24.1 | 75.9 | 100 | 0.45 | 108.92 |
| example 1 | | | | | |
| Example 1 | 25 | 75 | 100 | 0.53 | 108.91 |
| Example 2 | 28.1 | 71.9 | 100 | 0.55 | 108.87 |
| Example 3 | 28.2 | 71.8 | 100 | 0.58 | 108.49 |
| Example 4 | 28.4 | 71.6 | 100 | 0.65 | 108.00 |
| Example 5 | 30.1 | 69.9 | 100 | 0.68 | 106.87 |
| Example 6 | 33.9 | 66.1 | 100 | 0.68 | 106.77 |
| Example 7 | 40.2 | 59.8 | 100 | 0.69 | 106.65 |
| Example 8 | 50.1 | 49.9 | 100 | 0.74 | 105.08 |
| Example 9 | 60.7 | 39.3 | 100 | 0.80 | 104.74 |
| Example 10 | 70.2 | 29.8 | 100 | 0.81 | 102.77 |
| Example 11 | 71.6 | 28.4 | 100 | 0.82 | 102.75 |
| Example 12 | 72.0 | 28.0 | 100 | 0.86 | 97.21 |

TABLE 2

| | | | | | Evaluation of | |
|---|---|---|---|---|---|---|
| | | | Area ratio of | Presence of | capacitor sample | Evaluation of |
| | Resistance | Soft magnetic | ceramic | mixture | Withstand voltage | inductor |
| | layer | metal particle | particles | layer | (V/μm) | Ls (nH) |
| Example 3 | SiO2 | FeSi | 25% or more | Y | 0.58 | 108.49 |
| Comparative | SiO2 | FeSi | less than 25% | N | 0.45 | 108.92 |
| example 1 | | | | | | |
| Example 13 | ZrO2 | FeSi | 25% or more | Y | 0.56 | 108.05 |
| Comparative | ZrO2 | FeSi | less than 25% | N | 0.40 | 108.33 |
| example 2 | | | | | | |
| Example 14 | SiO2 | FeNi | 25% or more | Y | 0.56 | 184.44 |
| Comparative | SiO2 | FeNi | less than 25% | N | 0.41 | 185.16 |
| example 3 | | | | | | |
| Example 15 | SiO2 | FeNiCo | 25% or more | Y | 0.51 | 135.62 |
| Comparative | SiO2 | FeNiCo | less than 25% | N | 0.39 | 136.14 |
| example 4 | | | | | | |

### Evaluation 2

According to Table 2, it was confirmed that even when the material of the ceramic particle included in the resistance layer and the mixture layer were changed, the similar results as shown in Table 1 can be obtained. Note that, it was confirmed that silicon oxide was preferable as the ceramic particle. Also, according to Table 2, it was confirmed that even when the material of the metal particle included in the resistance layer and the mixture layer was changed, the similar results as shown in Table 1 can be obtained.

### REFERENCE SIGNS LISTS

1 . . . Multilayer coil component
2 . . . Element
3 . . . Terminal electrode
4 . . . Element body
4a . . . Interlayer area
4a . . . Magnetic material layer
4a1 . . . Metal particle
4a10 . . . Projection part
4a2 . . . Resin
4b . . . Resistance layer
4β1 . . . First resistance layer
4β2 . . . Second resistance layer
4b1 . . . Ceramic particle
4b2 . . . Resin
4c . . . Mixture layer
4d . . . Stress relieving layer
40a1 to 40a5 . . . Magnetic sheet layer
40b1 to 40b4 . . . Resistance pattern layer
40c1 to 40c4 . . . Mixture pattern layer
5 . . . Coil conductor
5a . . . Conductor layer
5a1, 5a2 . . . Lead-out electrode
50a1, 50a2, 50b to 50c . . . Conductor pattern layer

What is claimed is:

1. A multilayer coil component comprising:
a coil conductor arranged in a coil form and placed inside an element body,
a magnetic material layer comprising soft magnetic metal particles and arranged between a pair of conductor layers of the coil conductor adjacent along an axis direction of a cross section of the element body,
a resistance layer comprising ceramic particles having higher insulation resistance than the soft magnetic metal particles and arranged between the magnetic material layer and at least one of the pair of conductor layers, and
a mixture layer arranged between the magnetic material layer and the resistance layer, and comprising the ceramic particles between the soft magnetic metal particles in a predetermined ratio or higher.

2. The multilayer coil component according to claim 1, wherein an area ratio of an area including the ceramic particles in the mixture layer is 25% or more and 72% or less.

3. The multilayer coil component according to claim 1, wherein an average particle size of the ceramic particles is ½ or less than an average particle size of the soft magnetic metal particles.

4. The multilayer coil component according to claim 1, wherein the resistance layer comprises
a first resistance layer contacting at least one of the pair of conductor layers,
a second resistance layer contacting the mixture layer, and
a stress relieving layer arranged between the first resistance layer and the second resistance layer.

5. The multilayer coil component according to claim 1, wherein the resistance layer includes the ceramic particles and a resin, and the ceramic particles include silicon oxide particles and/or zirconium oxide particles.
